(19) United States
(12) Patent Application Publication
(10) Pub. No.: US 2011/0095010 A1
(43) Pub. Date: Apr. 28, 2011

(54) WATER TANK HEATER WITH PREDICTIVE HEATER FAILURE FEATURE

(76) Inventors: Frank A. Bondarowicz, Park Ridge, IL (US); Klaus Padtberg, Korbach (DE); Joseph E. Fabin, Elmwood Park, IL (US); Alan J. Varacins, Burlington, WI (US); William C. Schlieper, Tipp City, OH (US)

(21) Appl. No.: 12/605,009

(22) Filed: Oct. 23, 2009

(51) Int. Cl. H05B 1/00; F24H 1/18; H05B 3/02

(52) U.S. Cl. 219/209; 392/441; 219/391; 219/482

(57) ABSTRACT

A water heating system includes a tank for holding water and a resistive heating element associated with the tank for heating water in the tank. A control is connected for monitoring at least one resistance parameter of the resistive heating element as power is applied to the resistive heating element, the control configured to output a fault signal if the monitored resistance parameter exceeds a set threshold. The monitored parameter may be one or more of (i) a rate of resistance change during heater start-up, (ii) a rate of resistance change during steady state heater operation or (iii) a heater resistance corresponding to a set point in time following heater start-up.

### TECHNICAL FIELD

The present application relates generally to immersion type resistance heaters used for heating water and, more particularly, to water heating systems used in dishwashers or ovens.

### BACKGROUND

Resistive heating elements are commonly used in connection with commercial food equipment for generating heat. For example, such elements are used in steam ovens and dishwashers for heating water, where the resistive heating elements are immersed in the water that is to be heated. Lime scale or other insulating material tends to build up on the elements degrading the performance of the element by impeding the transfer of heat to the surrounding water.

In the past, temperature sensing devices have been used in attempt to identify abnormal or degraded heating elements. While this approach provides an accurate temperature measurement, it does so only at a single location on the element. If the buildup occurs at another location on the element, the degradation may go undetected. Using multiple temperature sensors along the element would be expensive and impractical.

Accordingly, it would be desirable and advantageous to provide a water heating system that more effectively identifies degradation of immersion type resistive heating elements.

### SUMMARY

In one aspect, a water heating system includes a tank for holding water and a resistive heating element associated with the tank for heating water in the tank. A control is connected for monitoring at least one resistance parameter of the resistive heating element as power is applied to the resistive heating element, the control configured to output a fault signal if the monitored resistance parameter exceeds a set threshold.

The monitored parameter may be one or more of (i) a rate of resistance change during heater start-up, (ii) a rate of resistance change during steady state heater operation or (iii) a heater resistance corresponding to a set point in time following heater start-up.

### BRIEF DESCRIPTION OF DRAWINGS

FIG. 1 is a schematic diagram of a steam oven incorporating the advantageous water tank heating system;

FIG. 2 is a schematic diagram of a dishwasher incorporating the advantageous water tank heating system; and

FIG. 3 is a graph illustrating resistance verses temperature for a resistive heating element.

### DETAILED DESCRIPTION

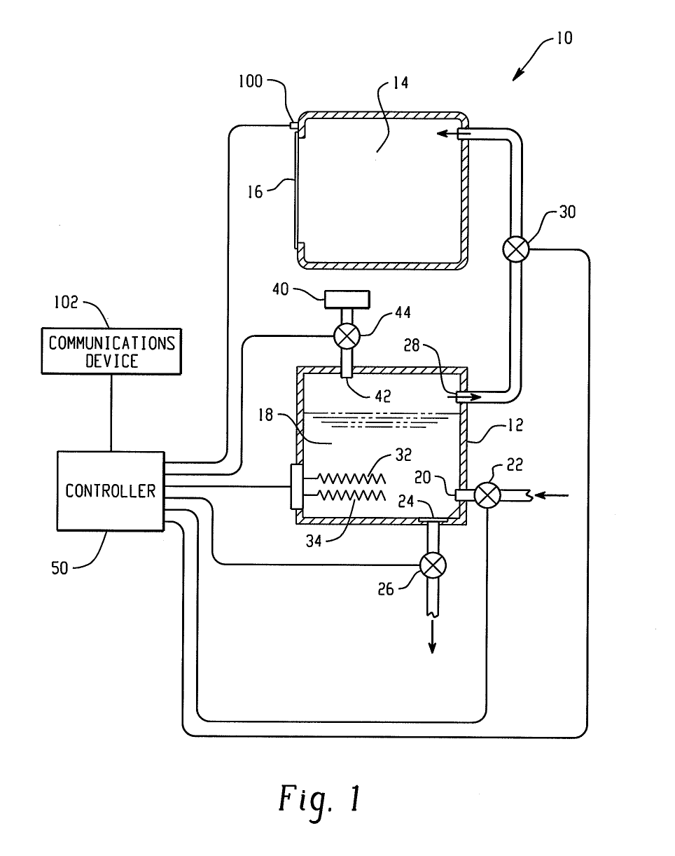

Referring to FIG. 1, in one implementation, the water heating system is implemented in the context of a steam cooking oven system 10 that includes a steam generator tank 12 for generating steam and a cooking chamber 14 that is used for cooking food placed therein. The cooking chamber 14 may be formed by an insulated housing and includes an access opening with a door 16 movable between open and closed conditions. The steam generator tank 12 forms a heating chamber 18 where water is heated to generate steam, a water inlet 20 and associated valve 22 through which water enters the heating chamber, a drain 24 and associated valve 26 through which water exits the heating chamber, and a steam outlet 28 and associated valve 30 through which steam exits the heating chamber and travels to the cooking chamber 14. Resistive heating elements 32 and 34 are shown schematically within the heating chamber 18. The heating elements 32 and 34 are of an electrical type and are used to heat the water within the heating chamber 18 so as to generate the steam.

A delime agent source 40 is connected to the heating chamber 18 via inlet 42 and associated valve 44. In some embodiments, the delime agent source 40 may be connected to the water inlet 20. In other arrangements, an opening (e.g., with removable cap) could be provided to facilitate manual introduction of the delime agent into the heating chamber 18. During a cleaning and draining operation, delime agent is introduced to the water in the heating chamber 18 to help remove lime and scale from the heating element.

A controller 50 is connected for controlling energization of the heating elements 32, 34 (e.g., in accordance with a cooking program of the steam oven) and may also be connected with the various valves and sensors (e.g., temperature sensors and/or water level sensors) of the system for proper oven control and may be connected with a communication device or channel 52 for sending and receiving messages to other computer devices (e.g., personal computers, cell phones, PDAs etc.). The controller 50 is also programmed or otherwise configured to monitor the resistive heating elements as will be described in further detail below.

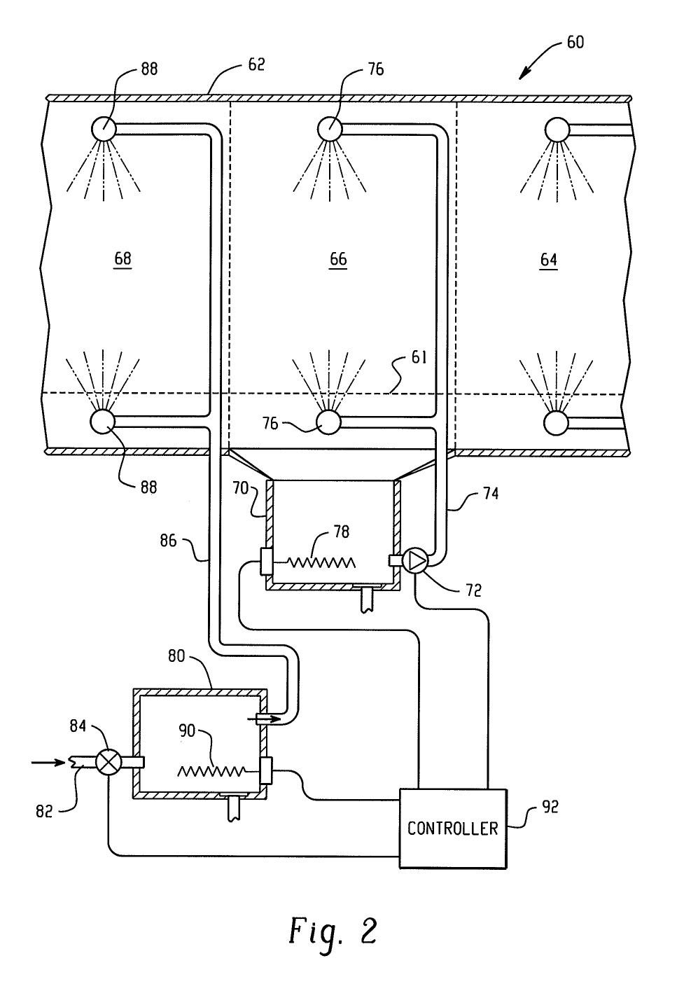

Referring to FIG. 2, in another implementation, the water heating system is implemented in the context of a conveyor-type dishwasher 60 in which items to be washed are moved (e.g., via a conveyance mechanism 61) through a housing 62 having multiple spray zones 64, 66 and 68. By way of example, spray zone 64 may be a pre-wash zone, zone 66 may be a wash zone and zone 68 may be a final rinse zone. As shown, the wash zone 66 includes an associated water tank 70, pump 72 and line 74 forming a recirculation path in which liquid is delivered from the tank 70 to nozzles 76 for spraying, and the sprayed liquid collects in the tank 70 for recirculation. A resistive heating element 78 is located in the tank for heating the water (e.g., water and cleaning agent) to enhance the cleaning operation. The final rinse zone 68 includes an associated booster heater tank 80 that receives water from a fresh water input source 82 through a valve 84 or other feed structure. The booster tank is connected to deliver water via line 86 to nozzles 88 in the final rinse zone 68, and includes a resistive heating element 90 for heating the rinse water. The booster tank could include an associated delime system similar to that described above for tank 12. A controller 92 is connected to control energization of the resistive heating elements 78 and 92 (e.g., in accordance with a cleaning program of the dishwasher), as well as the operation of the valves and pumps in the machine. The controller 92 is also programmed or otherwise configured to monitor the resistive heating elements as will be described in further detail below.

In a alternative dishwasher implementation, the dishwasher may be formed as a box-type machine (also known as a batch-type or door-type machine) in which dishes are manually placed in a chamber for washing and rinsing sprays, and the dishes are then removed after cleaning. Such machines, which could be hood-type machines or undercounter type machines, may include one or more resistive heating elements in the sump tank of the machine (e.g., from which water is pumped and delivered to nozzles for spraying in a recirculated manner) and/or in a booster heater tank used for heating rinse water that is delivered to spray nozzles of the machine.

The electrical resistance of a conductor is dependent on the subatomic collisions within the material. The energy of subatomic collisions is related to the temperature of the conductor and as such the electrical resistance of a conductor is proportional to its temperature as defined by the following equation ΔR/R0=αΔT, where:

ΔR=change in resistance;

R₀=Initial Resistance of heating element;

α=Temperature Coefficient of Resistance; and

ΔT=Change in Temperature.

By measuring voltage across and current through the resistive element of a heater it is possible to calculate the resistance of the heater. Any localized increase in resistance will reduce the current flow in the overall element.

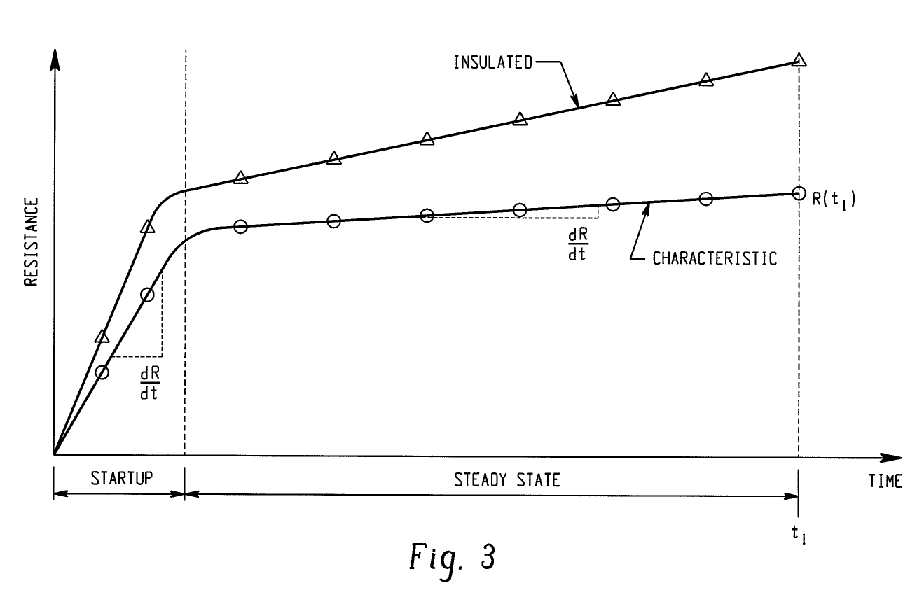

Referring to FIG. 3, a heater's characteristic resistance can be separated into three distinct metrics, namely:
[dR/dt]_{characteristic}^{start-up}—the rate of resistance change upon start-up of the element (e.g., the rate of resistance change occurring upon initial energization of the element while the element temperature increases rapidly);
[dR/dt]_{characteristic}^{steadystate}—the rate of resistance change during steady state operation of the heater; and
R(t₁)—the resistance value of the element at a specified point in time following either initial energization or reaching of steady state operation.
   These characteristic resistance metrics or parameters can be determined for any given heating element by running the heating element through a calibration operation prior to or once the element is installed in the machine in which the element will be operating. In this regard, the machine controller 50, 92 can be programmed or otherwise configured to carry out the calibration procedure by actually monitoring voltage and resistance during energization of the element to calculate resistance values and, based upon those calculated resistance values, in turn calculate or otherwise define the metrics that are then automatically stored in memory of the controller 50, 92 for later use. The controller could, in addition or alternatively, be configured to determine the area under the curve for each specific region (e.g., start up or steady state) or, in the case of the resistance at a point in time metric, the total area under the resistance curve up to that point in time, as an indicator of the given metric.

During normal operation of a resistance heating element in a machine, the controller 50, 92 monitors the element to determine if one or more resistance parameters or metrics of the element changes in a manner that is indicative of significant degradation of the element. This monitoring operation would, preferably, take place during start-up and/or before the element reaches thermal equilibrium with the water (or other fluid) being heated. Specifically, the controller 50, 92 would monitor voltage and current, calculate resistance values and, based upon the calculated resistance values calculate or otherwise define the rate change metrics and/or actual resistance at a point in time metric, or indicators thereof, and compare them to the corresponding stored characteristic metrics for the element. As a heater becomes insulated through extended use (e.g., due to significant lime build up) the resistance verses time graph translates as shown in FIG. 3. Specifically, the rate of resistance change increases for both start up and steady state and the resistance at the specified point in time t₁ increases as well.

The controller 50, 92 compares the newly measured and calculated metric values to those in memory. If the change in the metric from the stored characteristic metric is within an acceptable or set window, range or tolerance of the stored characteristic metric, the monitored metric is determined to be within or less than a set threshold that has been established for the metric. On the other hand, if the monitored metric is outside the window or range, the metric is determined to exceed a set threshold for the metric, and the controller outputs a fault signal.

In one implementation, the fault signal is used to alert a machine operator to potential element failure by effecting energization of an annuciator element 100 (see FIG. 1) of the machine, such as a light, display or audio output device. Thus, the system identifies a degraded non-failure state of the element (i.e., a state in which effective operation of the element is degraded, but the element has not yet failed completely). The fault signal may also, or alternatively, be delivered to a communication channel or link 102 (FIG. 3) to effect generation of an email, text message or voice mail to a service person phone, PDA or other computer device. The fault signal could also be stored in controller memory for subsequent retrieval by a service person via a communications interface of the controller. In other implementations, the fault signal may effect shut down of energization of the element and/or other operations of the machine in which the element is located. More advanced systems may include multiple threshold levels, such as a first threshold that, when exceeded, produces a fault signal that effects operation of the annunciator and a second, higher threshold that, when exceeded, produces a fault signal that shuts down power to the element and/or machine. Referring to FIG. 3, the fault signal could also be utilized to trigger an automated delime operation of the tank 12, by which the controller operates the valve 42 or other flow control to deliver delime agent into the tank.

The subject monitoring operation could also be utilized to identify a condition when the resistive heating element is not immersed. In such an embodiment the temperature of the resistive heating element will rise rapidly and thus the resistance of the element will also rise rapidly. A rate of change in excess of a certain threshold rate of change, or a total resistance in excess of a certain threshold resistance, would indicate a lack of immersion of the element, prompting shut down of power to the element and/or triggering of an annunciator or service person communication that identifies the problem. The threshold levels might typically be higher than the set threshold levels that merely indicated a degraded non-failure state of the element.

Although the invention has been described and illustrated in detail it is to be clearly understood that the same is intended by way of illustration and example only and is not intended to be taken by way of limitation. For example, in some implementations, such as where the voltage applied to the resistive heating element is constant and does not vary over time, the current may only need to be monitored to determine resistance, and the determination could be from a calculation or other means, such as a look-up table. Moreover, while the system has been described and discussed in the context of a steam oven and/or dishwasher, the element monitoring technique described herein could be utilized in other type of machines. It is recognized that numerous other variations exist, including both narrowing and broadening variations of the appended claims.

What is claimed is:

1. A water heating system, comprising:
a tank for holding water;
a resistive heating element associated with the tank for heating water in the tank;
a control connected for monitoring at least one resistance parameter of the resistive heating element as power is applied to the resistive heating element, the control configured to output a fault signal if the monitored resistance parameter exceeds a set threshold.

2. The water heating system of claim 1, wherein the resistance parameter is one or more of (i) a rate of resistance change during heater start-up, (ii) a rate of resistance change during steady state heater operation or (iii) a heater resistance corresponding to a set point in time following heater start-up.

3. The water heating system of claim 1, wherein the control monitors both applied heater voltage and actual heater current when monitoring the resistance parameter, and determines resistance values therefrom.

4. The water heating system of claim 1, wherein applied heater voltage is constant, the control monitors actual heater current and determines resistance values therefrom.

5. The water heating system of claim 1 wherein the set threshold is established in accordance with a calibration procedure of the control and is stored in memory of the control.

6. The water heating system of claim 5 wherein the set threshold is established as a specified departure of the monitored resistance parameter from a level of the monitored resistance parameter determined during the calibration procedure.

8. The water heating apparatus of claim 6 wherein the set threshold identifies a degraded non-failure state of the resistive heating element.

9. The water heating apparatus of claim 1 wherein the set threshold corresponds to a non-immersed state of the resistive heating element.

10. The water heating system of claim 1 wherein the water heating system is incorporated into a dishwasher apparatus, and the tank comprises one of (i) a booster heater tank for heating rinse water prior to spraying of rinse water or (ii) a recirculation tank including a recirculation line for delivering water from the tank to spray nozzles for spraying, the sprayed water returning to the tank after spraying.

11. The water heating system of claim 1 wherein the water heating system is incorporated into a steam oven including a steam cooking chamber, the tank defined by a steam generator tank having an outlet plumbed to deliver steam to the steam cooking chamber.

12. The water heating system of claim 1 wherein the fault signal effects one of (i) shut down of power to the resistive heating element or (ii) operation of the resistive heating element at a reduced power level.

13. The water heating system of claim 1 where the fault signal effects operation of an operator annunciator.

14. The water heating system of claim 13 wherein the operator annunciator comprises at least one of a light element, an audio element or a communication device signal.

15. The water heating system of claim 1 wherein the fault signal effects operation of an automated delime operation in the tank.

16. The water heating system of claim 1 wherein the fault signal is stored in memory for subsequent reading via a communications interface and/or is sent to a communication channel.

17. The water heating system of claim 1 wherein the set threshold is a first set threshold, the fault signal is a first fault signal that effects operation of an operator annunciator, the control is configured to output a second fault signal if the monitored resistance parameter exceeds a second set threshold, the second set threshold higher than the first set threshold, the second fault signal effecting shut down of power to the resistive heating element.

18. The water heating system of claim 1 wherein;
the resistance parameter is one or more of (i) a rate of resistance change during heater start-up, (ii) a rate of resistance change during steady state heater operation or (iii) a heater resistance corresponding to a set point in time following heater start-up;
the control monitors one or both of applied heater voltage and actual heater current when monitoring the resistance parameter, and determines resistance values therefrom;
the set threshold is established in accordance with a calibration procedure of the control and is stored in memory of the control;
the water heating system is incorporated into one of:
a dishwasher apparatus, and the tank comprises one of (i) a booster heater tank for heating rinse water prior to spraying of rinse water or (ii) a recirculation tank including a recirculation line for delivering water from the tank to spray nozzles for spraying, the sprayed water returning to the tank after spraying; or
a steam oven including a steam cooking chamber, the tank defined by a steam generator tank having an outlet plumbed to deliver steam to the steam cooking chamber.

19. In a water heating system including a tank for holding water, a resistive heating element within the tank for heating water in the tank, and a control associated with the resistive heating element, a method of identifying a degraded non-failure state of the resistive heating element, comprising:
monitoring at least one resistance parameter of the resistive heating element as power is applied to the resistive heating element, and producing a fault signal if the monitored resistance parameter exceeds a set threshold that is indicative of the degraded non-failure state.

20. The method of claim 19 wherein the resistance parameter is one or more of (i) a rate of resistance change during heater start-up, (ii) a rate of resistance change during steady state heater operation or (iii) a heater resistance corresponding to a set point in time following heater start-up.

21. A heating system, comprising:
a resistive heating element;
a control connected for monitoring at least one resistance parameter of the resistive heating element as power is applied to the resistive heating element, the control configured to output a fault signal if the monitored resistance parameter exceeds a set threshold that is indicative of a degraded non-failure state of the resistive heating element.

22. The heating system of claim 21, wherein the resistance parameter is one or more of (i) a rate of resistance change during heater start-up, (ii) a rate of resistance change during steady state heater operation or (iii) a heater resistance corresponding to a set point in time following heater start-up.

23. The heating system of claim 21 wherein the set threshold is established in accordance with a calibration procedure of the control and is stored in memory of the control.

24. The heating system of claim 23 wherein the set threshold is established as a specified departure of the monitored resistance parameter from a level of the monitored resistance parameter determined during the calibration procedure.
